(19) United States
(12) Patent Application Publication
(10) Pub. No.: US 2025/0252876 A1
(43) Pub. Date: Aug. 7, 2025

(54) MULTI-MICRODEVICE LENS UNIT

(71) Applicant: Meta Platforms Technologies, LLC, Menlo Park, CA (US)

(72) Inventors: Yasuo Morimoto, Cupertino, CA (US); Jiang Zhu, Cupertino, CA (US); Kuan Pei Yap, San Jose, CA (US); John Ho, Sunnyvale, CA (US)

(21) Appl. No.: 18/431,006

(22) Filed: Feb. 2, 2024

(51) Int. Cl. G09G 3/00; G02B 27/00; G02B 27/01; G06F 3/01; H01Q 1/24; H01Q 1/38

(52) U.S. Cl. CPC G09G 3/001; G02B 27/0093; G02B 27/0172; G06F 3/013; H01Q 1/248; H01Q 1/38; G02B 2027/0138; G02B 2027/0178; G09G 2354/00; G09G 2360/14

(57) ABSTRACT

The disclosed system may include (1) a support structure, (2) a lens, mounted to the support structure, (3) a power source, and (4) a multi-microdevice unit, positioned on the lens, that includes a first microdevice powered by a first type of current, a second microdevice powered by a second type of current, and a microconverter. The power source may transmit the first type of current to the multi-microdevice where the first type of current is received by the first microdevice and by the microconverter. The microconverter may convert the first type of current, received from the power source, to the second type of current and transmit the converted second type of current to the second microdevice within the multi-microdevice unit. Various other wearable devices, apparatuses, and methods of manufacturing are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a system 100 with a multi-microdevice unit.

FIG. 2A depicts an exemplary pair of glasses with a lens embedded with light-emitting elements and cameras.

FIG. 2B depicts the exemplary pair of glasses from FIG. 2A in which the light-emitting elements are circled.

FIG. 2C depicts the exemplary pair of glasses from FIG. 2A in which the cameras are circled.

FIG. 3 depicts light, emitted from a light-emitting element, that is reflected off a user's eye and received by a camera.

FIG. 4 depicts an exemplary non-linear trace in a conductive film. FIG. 4 also depicts a non-periodic ladder juxtaposed with a periodic ladder.

FIG. 5 depicts multiple exemplary multi-microdevice units positioned around a lens according to a first exemplary configuration.

FIG. 6A depicts multiple exemplary multi-microdevice units positioned around a lens according to a second exemplary configuration.

FIG. 6B depicts multiple exemplary multi-microdevice units positioned around a lens according to a third exemplary configuration.

FIG. 7 depicts multiple exemplary multi-microdevice units positioned around a lens according to a fourth exemplary configuration.

FIG. 8 depicts an exemplary method of manufacture corresponding to the system of FIG. 1.

FIG. 9 depicts an exemplary augmented-reality system that may include the lens described in connection with FIGS. 1-5.

FIG. 10 depicts an exemplary virtual-reality system that may include the electronic display described in connection with FIGS. 1-5.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

This disclosure is generally directed to a multi-microdevice unit that includes at least three microdevices: a first microdevice powered by a first type of current, a second microdevice powered by a second type of current, and a microconverter configured to convert the first type of current to the second type of current. In some examples, a power source may transmit the first type of current to the multi-microdevice where the first type of current is received by the first microdevice and the microconverter. The microconverter may covert the first type of current to the second type of current and transmit the converted second type of current to the second microdevice. In some examples, the power source may transmit power to the multi-microdevice unit via one or more feeding traces (e.g., conductive pathways) and/or the converter may transmit power to the second microdevice via one or more feeding traces. In such examples, this disclosure may also include reducing the feeding traces to transparent components. In one embodiment, the multi-microdevice unit may be embedded within a conductive film, applied to a substrate that is coupled to a support structure. In some examples, the substrate (with the conductive film) may be used in an electronic display. The electronic display can be used in any of a variety of contexts (e.g., as a lens for a pair of augmented reality glasses, a display element of a mobile device and/or an artificial reality headset, a touchscreen, etc.). In one embodiment, the multi-microdevice unit may include (1) a microantenna, which may be powered by alternating current, (2) one or more micro light-emitting elements (LEDs), which may be powered by direct current (e.g., LEDs that illuminate human visible light and/or LEDs that illuminate non-visible light such as infrared ray), and (3) a rectifier that converts alternating current to direct current.

In examples in which the disclosed system includes feeding traces that connect to a multi-microdevice unit that is positioned in a substrate (i.e., a transparent substrate) that must be seen through (e.g., a lens), visible traces may be a distraction (e.g., to users looking through the lens). As such, to reduce the visibility of traces, the present application also discloses creating and using traces that are non-linear (as non-linear lines are less easily processed by the human visual system than straight lines). In some examples, each of the multiple traces can take the form of a non-linear (e.g., undulating) line. Additionally or alternatively, the multiple traces can be formed into a ladder configuration (e.g., with non-periodic junctions). In some examples, the present application discloses only using traces that are beneath a designated width and/or thickness and bundling multiple traces together (each of which are beneath the designated width and/or thickness) if a single trace cannot provide the electrical transmission and/or resistance needs of a particular connection. In some such examples, the multiple traces may be formed into a ladder configuration (e.g., a non-periodic ladder configuration with non-linear segments).

In some examples, a conductive film (e.g., associated with the multi-microdevice unit disclosed here) may include a conductive metal mesh. In one such example, the metal mesh may have variable density (e.g., with a greater mesh density at a peripheral area of the film than at a central area of the film). In some examples, the metal mesh may be configured to reduce its visibility. For example, the metal mesh may include an overcoat, added via a dye sublimation printing process, to reduce reflection and/or glare. As another example, a height of the metal mesh may be modified by an image patterning laser (e.g., to a height that increases optical transparency).

Features from any of the embodiments described herein may be used in combination with one another in accordance with the general principles described herein. These and other embodiments, features, and advantages will be more fully understood upon reading the following detailed description in conjunction with the accompanying drawings and claims.

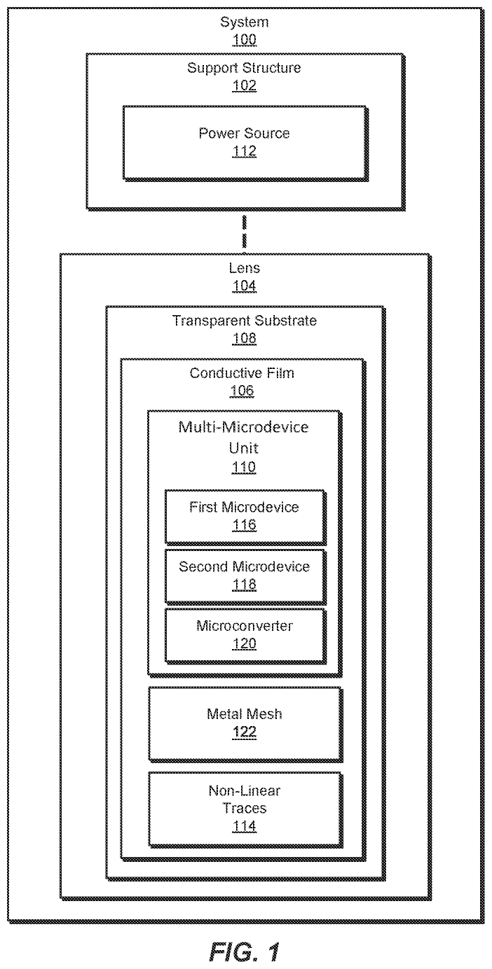

FIG. 1 illustrates an embodiment of a system 100 with a support structure 102 coupled to a lens 104. Lens 104 may include a conductive film 106 (e.g., applied to a transparent substrate 108). Lens 104 may also include a multi-microdevice unit 110. In some examples, multi-microdevice unit 110 may be embedded within conductive film 106, as illustrated in FIG. 1. System 100 may also include a power source 112. In some examples, power source 112 may be integrated with support structure 102. In some examples, multi-microdevice unit 110 may be connected to power source 112 via one or more non-linear traces 114. In some examples, system 100 may correspond to a wearable device (e.g., a pair of augmented reality glasses, a wearable artificial reality headset, etc.).

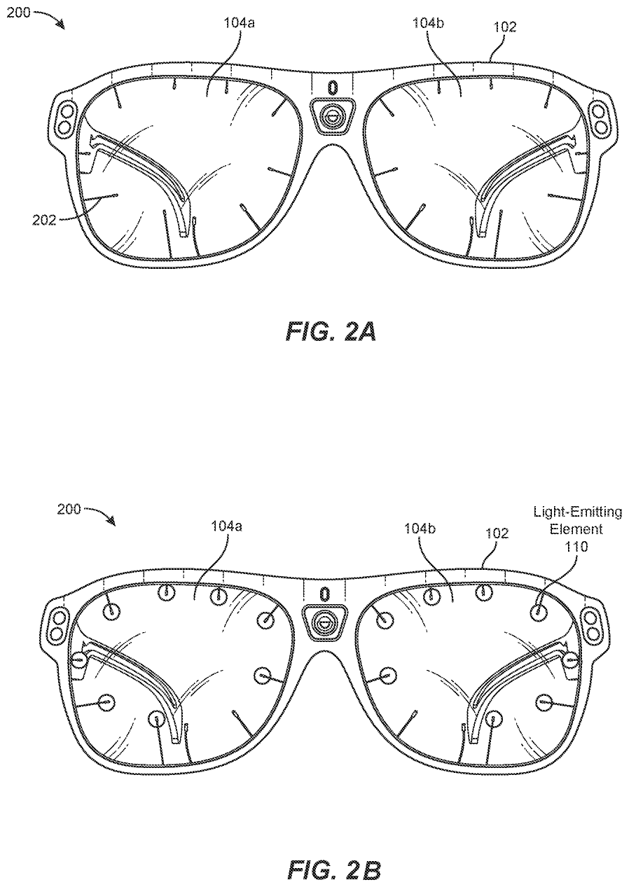

Lens 104 may represent any type or form of optical substrate and support structure 102 may represent any type or form of structure that physically supports lens 104. In some examples, support structure 102 may represent a wearable device (or a component of a wearable device) and lens 104 may represent an electronic display placed within the wearable device. In one example, as illustrated in FIGS. 2A-2C, lens 104 may represent a lens within a pair of augmented reality glass lenses 200 (labeled as lens 104(a) and lens 104(b) in FIGS. 2A-2C) and support structure 102 may represent a frame.

Conductive film 106 may represent any type or form of layer (e.g., film), applied to transparent substrate 108, that conducts electricity. Conductive film 106 may include a support system, such as conductive metal mesh, with which one or more elements (e.g., multi-microdevice unit 110) may be embedded. Additionally or alternatively, elements may be directly integrated (e.g., embedded) with transparent substrate 108. For example, elements may be casted, laminated, and/or printed onto transparent substrate 108.

Multi-microdevice unit 110 may represent any type or form of physical unit (e.g., complex) that includes multiple microdevices. In some examples, two or more of the microdevices may be interconnected within the unit (e.g., connected via wire traces). In one embodiment, multi-microdevice unit 110 may include a first microdevice 116 (e.g., a microantenna) powered by a first type of current (e.g., Alternating Current (AC)), a second microdevice 118 (e.g., one or more light-emitting elements (LEDs)) powered by a second type of current (e.g., Direct Current (DC)), and a microconverter 120 (e.g., a rectifier configured to convert AC to DC).

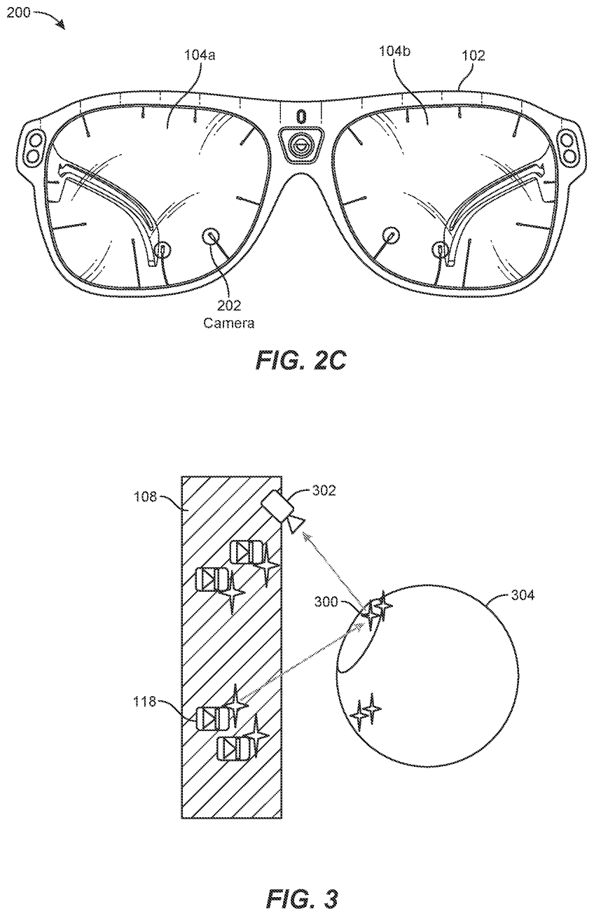

A light-emitting element may represent any type of element, which may be integrated with conductive film 106 and/or transparent substrate 108, that emits light. In some examples, a light-emitting element may represent a light-emitting diode (LED). A light-emitting element may be used in a variety of contexts (e.g., to enable a variety of functionalities). In some examples, a light-emitting element may be used (e.g., as part of a pair of augmented reality glasses) to track user-gaze. In these examples (as illustrated in FIG. 3), a light-emitting element (labeled in FIG. 3 as second microdevice 118) may emit a light 300 onto an eye 302 of a user (e.g., wearing the pair of augmented reality glasses). The light may reflect off eye 302 and the reflected light may be captured by a camera 304 (e.g., embedded within transparent substrate 108 or some other element of the pair of augmented reality glasses such as a frame). FIGS. 2A-2C depict an exemplary embodiment of lens 104 into which a set of light-emitting elements (circled in FIG. 2B) and cameras (circled in FIG. 2C) are embedded.

A microantenna may refer to any type or form of device that transmits and/or receives radio frequency signals. In some examples (e.g., in which system 100 corresponds to a wearable device such as a pair of artificial reality glasses), the microantenna may enable wireless communication (e.g., enabling system 100 to establish a connection with other devices, networks, or sensors). In some embodiments, the microantenna may represent a wireless metal mesh antenna (e.g., in which the shape of the microantenna is defined by a cutout in surrounding metal mesh dummy fill and/or in which antenna is defined by metal mesh without dummy fill). In one such embodiment, the microantenna may feature a gradient mesh density such that it is less dense in the center than it is along its edges. In some embodiments in which the microantenna represents a metal mesh antenna, the additional elements of multi-microdevice unit 110 may be positioned within the microantenna.

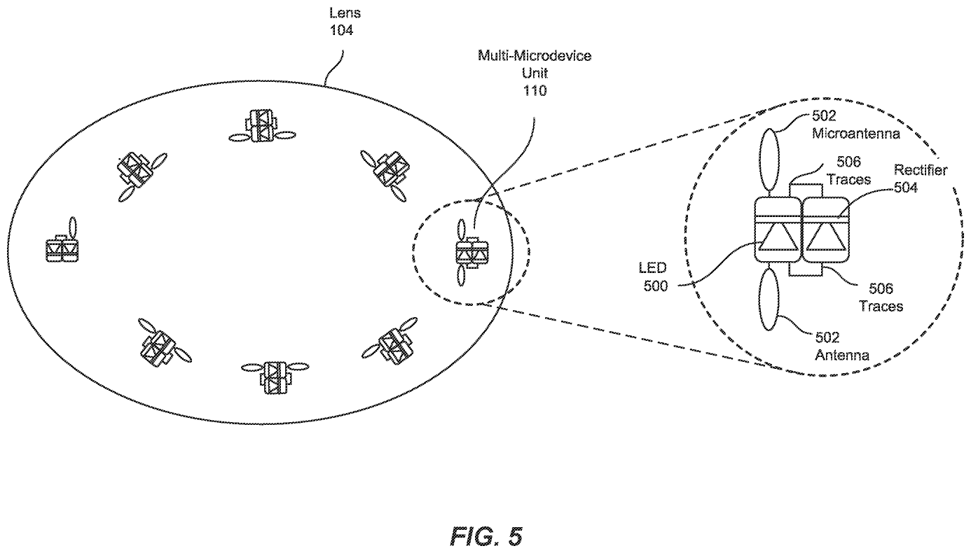

In examples in which first microdevice 116 represents a microantenna, the microantenna may take any shape and be any size (e.g., ovular, rectangular, a ring shape, etc.). Some exemplary shapes will be described in greater detail below in connection with FIGS. 5, 6A, 6B, and 7.

A microconverter may refer to any type or form of microdevice that transmits a first type of current to a second type of current. In one example, the microconverter may represent a rectifier configured to convert alternating current (AC) (e.g., used to power a microantenna of multi-microdevice unit 110) to direct current (DC) (e.g., used to power an LED of multi-microdevice unit 110). Additionally or alternatively, the microconverter may convert a current operating above a threshold range to current operating below the threshold range. Relatedly, in another example the microconverter may convert a current operating below a threshold range to current operating above the threshold range.

Power source 112 may represent any type or form of electronic device or component that provides power to an element (e.g., an element integrated with lens 104). In some examples, power source 112 may supply power to multi-microdevice unit 110 but only in the form of the first type of current used to power first microdevice 116 (e.g., without supplying power in the form of the second type of current used to power second microdevice 118). In some examples, power source 112 may operate as part of a controller that digitally manages (e.g., regulates) the operation of an element (e.g., an element such as multi-microdevice unit 110).

Non-linear traces 114 may represent any type or form of conductive pathway that connects two elements (e.g., multi-microdevice unit 110 and power source 112, power source 112 and first microdevice 116, power source 112 and microconverter 120, microconverter 120 and second microdevice 118, etc.). In some examples, non-linear traces 114 may be facilitate the transmission of electrical current between the two elements (e.g., from a first element to a second element). In some examples, the first element (e.g., power source 112) may be integrated with a support structure that houses lens 104 (e.g., support structure 102) and the second element (e.g., first microdevice 116 and/or microconverter 120) may be integrated with lens 104 (e.g., embedded with conductive film 106).

Non-linear traces 114 may be formed from any conductive material. Exemplary materials include, without limitation, indium tin oxide (ITO), silver nanowire, copper, graphene, a polymer-metal composite, gold, aluminum, etc. Traditionally, traces take a linear form. FIGS. 2A-2C show exemplary linear traces (e.g., trace 202), which take the form of straight lines, extending into lens 104 to connect a controller with light-emitting elements or camera elements. In one embodiment, the present application discloses configuring traces to take a non-linear form to reduce their visibility.

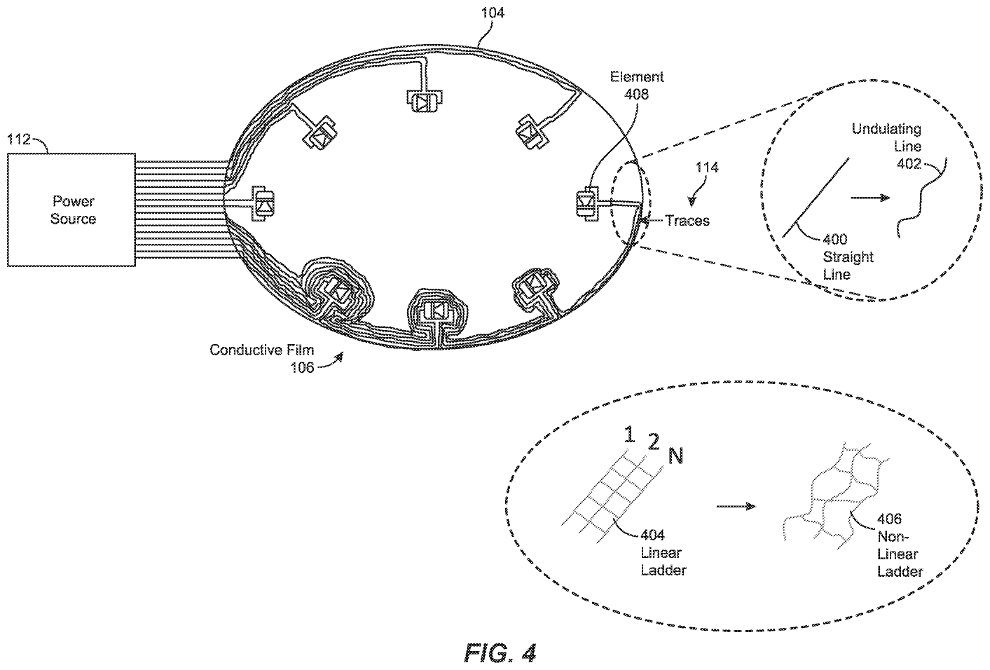

Non-linear traces 114 may be configured to take a variety of non-linear forms. In one example, non-linear traces 114 may take the form of an undulating line. FIG. 4 depicts an exemplary lens 104, with an element 408 embedded within conductive film 106, in which a trace takes the form of an undulating line 402 instead of a straight line 400. In some examples, the undulating line may represent a randomized lines (e.g., a line that undulates non-periodically and/or at random). In one embodiment, in which non-linear traces 114 includes multiple traces, the traces may take the form of a non-periodic ladder. FIG. 4 depicts a non-linear ladder 406 that may be used instead of a linear latter 404. In this example, the ladder may have any number of vertically extending segments and any number of horizontal segments intersecting the vertically extending segments. In some examples, the locations of the junction points (e.g., between the vertical and horizontal segments) may be non-periodic (e.g., randomized). Additionally or alternatively, the segments themselves may non-linear (e.g., taking the form of an undulating line). FIG. 4 depicts traces 114 being used to supply power to element 408. Element 408 may represent any type or form of element. In some examples, element 408 may represent multi-microdevice unit 110.

In some examples, the traces disclosed herein may be configured to stay at or beneath a determined width and/or thickness (e.g., a width/thickness at which traces are optically transparent or nearly transparent). As a specific example, the traces may be configured to stay in a width range of 10-25 um and a thickness range of 5-13 um. In some such examples, the electrical transmission and/or resistance needs of a particular connection between two elements may not be satisfied by a single trace (e.g., where the single trace is limited by the determined width and thickness range). In these examples, instead of increasing the width and thickness of a single trace, the number of traces within the particular connection may be increased, until the electrical transmission and/or resistance needs of the particular connection are met. In some such examples, the multiple traces may be formed into a non-periodic ladder (e.g., with the ladder configuration described previously).

In some examples, lens 104 (e.g., conductive film 106 of lens 104) may include a metal mesh 122. Metal mesh 122 may generally represent any type or form of electrically conductive mesh. In some examples, metal mesh 122 may take the form of a grid (e.g., a non-periodic grid). In some examples, metal mesh 122 may include multiple integrated patterns. For example, metal mesh 122 may include a non-periodic pattern in certain areas (e.g., areas corresponding to a region of lens 104 through which a user gazes) and a solid and/or periodic pattern in other areas (e.g., areas corresponding to a region of lens 104 that are positioned behind support structure 102 and/or a cosmetic cover of support structure 102).

Metal mesh 122 may be formed from any type of conductive material. Exemplary materials include, without limitation, carbon nanotubes, graphene, or metallic nanotubes. In some examples, metal mesh 122 may be processed to reduce its glare or increase its transparency. For example, an overcoat may be applied to metal mesh 122 (e.g., via a dye sublimation printing process) to reduce reflection and/or glare. In another example, a height of metal mesh 122 may be modified (e.g., by an image patterning laser) to increase the optical transparency of metal mesh 122.

Metal mesh 122 may enable a variety of functionalities (e.g., gaze tracking, active dimming, etc.). In some examples, metal mesh 122 may create a support system to which one or more elements may be coupled (e.g., a light-emitting element, a camera, an antenna, etc.). In one embodiment, metal mesh 122 may represent a metal mesh antenna. In some examples, metal mesh 122 may have variable density. For example, a density of metal mesh 122 may be greater at a peripheral area of conductive film 106 (e.g., around the perimeter of lens 104) than at a central area of conductive film 106 (e.g., corresponding to an area of lens 104 through which a user is expected to gaze). In some examples, the central area may include a metal mesh dummy filling (e.g., a disconnected mesh structure). In other examples, the central area may include non-dummy filing (e.g., a connected mesh structure).

Multi-microdevice unit 110, and the microdevices within multi-microdevice unit 110, may take any form and may be integrated with (e.g., positioned within) lens 104 in any configuration. FIG. 5 illustrates an exemplary multi-microdevice unit 110 that includes a micro LED 500, a microantenna 502, and a rectifier 504. In this example, portions of microantenna 502 are positioned on either side of rectifier 504 and rectifier 504 is positioned next to LED 500. Rectifier 504 and LED 500 are connected via traces 506 and a power supply (not pictured) is connected to microantenna 502 and rectifier 504 via traces. While the traces shown in FIG. 5 are linear, these traces may also be non-linear, as described above.

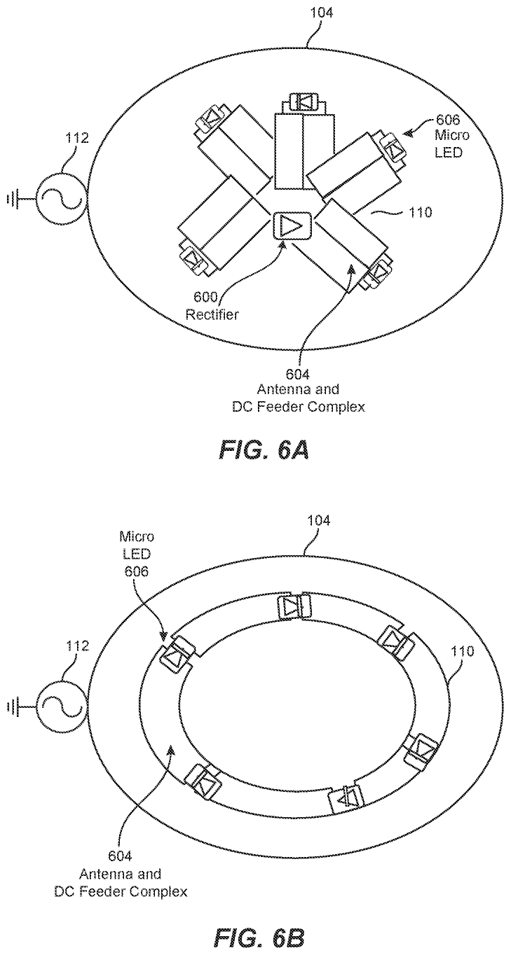

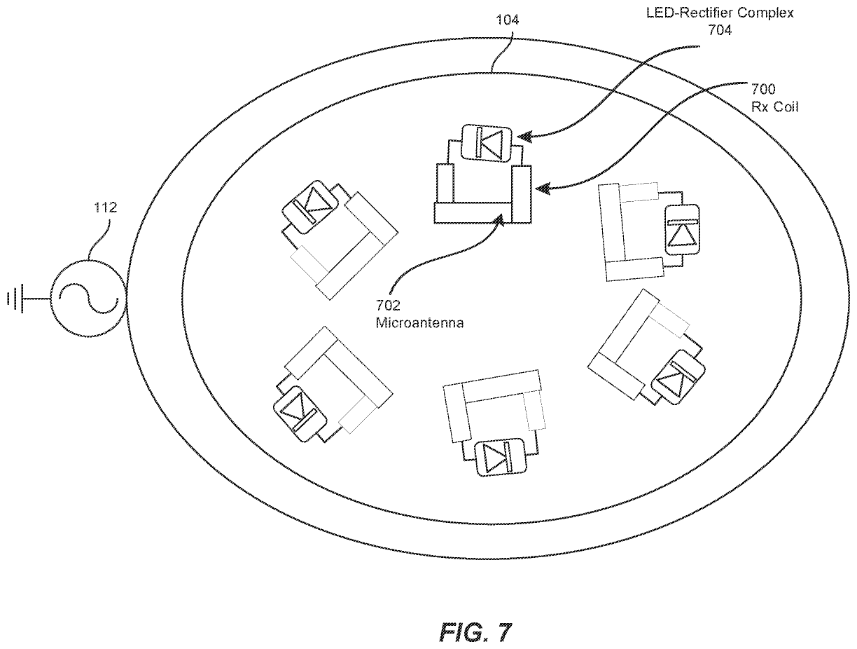

FIG. 6A illustrates an exemplary multi-microdevice unit 110 that includes a rectifier 600 positioned centrally to multiple antenna and DC feeder complexes (e.g., antenna and DC feeder complex 604), where each antenna and DC feeder Complex is connected to a micro LED (e.g., micro LED 606). The antenna and DC feeder complex may represent a unit that includes both a microantenna and a rectifier. FIG. 6B illustrates an exemplary multi-microdevice unit 110 that forms a ring around a perimeter of lens 104 and includes multiple antenna and DC feeder complexes (e.g., antenna and DC complex 604) and one or more micro LEDs (e.g., micro LED 606). FIG. 7 illustrates an exemplary multi-microdevice unit 110 in which a transmitting coil is positioned outside of a lens active region of lens 104 (e.g., within a support structure such as a frame for lens 104). In this example, multi-microdevice unit 110 may include a receiving coil 700, a microantenna 702, and an LED-rectifier unit 704 (e.g., a unit that includes both a micro LED and a rectifier). In some examples (as illustrated in FIG. 7), power source 112 may transmit lower frequency (e.g., MHz and/or KHz) which could directly excite LEDs (e.g., without the need for a rectifier). In these examples, instead of an LED-rectifier unit 704, multi-microdevice unit 110 may simply include one or more micro LEDs.

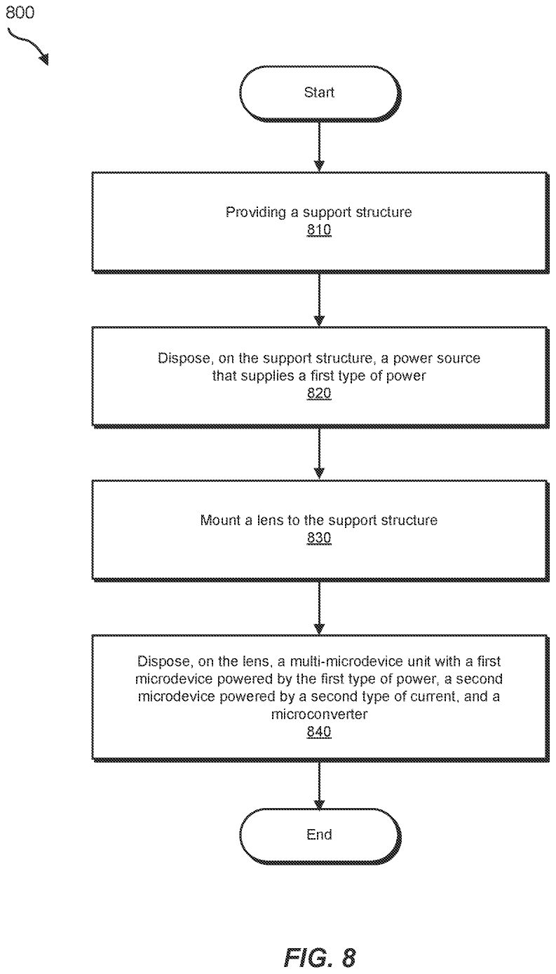

FIG. 8 depicts an exemplary method 800 of manufacture. At step 810, one or more of the systems described herein may provide a support structure (support structure 102 in FIG. 1). Then, at step 820, one or more of the systems described herein may dispose, on the support structure, a power source that supplies a first type of power. At step 830, one or more of the systems may mount a lens (e.g., lens 104) to the support structure and, at step 840, may dispose, on the lens, a multi-microdevice unit (e.g., multi-microdevice unit 110) with a first microdevice (e.g., first microdevice 116) powered by the first type of power, a second microdevice (e.g., second microdevice 118) powered by a second type of current, and a microconverter (e.g., microconverter 120). In some examples, step 840 may also include assembling the first microdevice, the second microdevice, and the microconverter to form the multi-microdevice unit. Additionally or alternatively, step 840 may also include connecting the light-emitting element to the controller via one or more traces (e.g., non-linear traces). The one or more systems described herein may perform the steps of method 800 using any of the systems, processes, elements, or features described herein (e.g., in connection with FIGS. 1-7).

### Example Embodiments

Example 1: A system including a support structure, a lens, mounted to the support structure, a power source, and a multi-microdevice unit, positioned on the lens, including a first microdevice powered by a first type of current, a second microdevice powered by a second type of current, and a microconverter, where: the power source transmits the first type of current to the multi-microdevice where the first type of current is received by the first microdevice and by the microconverter, and the microconverter converts the first type of current, received from the power source, to the second type of current and transmits the converted second type of current to the second microdevice within the multi-microdevice unit.

Example 2: The system of example 1, where the multi-microdevice unit includes an antenna-LED unit.

Example 3: The system of example 2, where the first microdevice includes an antenna, the second microdevice includes one or more light emitting diodes (LEDs), and the microconverter comprise a rectifier.

Example 4: The system of example 3, further including a camera configured to detect an illuminance, emitted by at least one of the one or more light-emitting elements, that has reflected off an eye of a user.

Example 5: The system of example 1, where the first type of current includes alternating current and the second type of current includes direct current.

Example 6: The system of example 1, where the first type of current includes a current with an operating frequency above a threshold range, and the second type of current includes a current with an operating frequency below the threshold range.

Example 7: The system of example 1, where the power source is embedded within the support structure.

Example 8: The system of example 1, where the power source transmits the first type of current to the multi-microdevice unit via one or more non-linear traces.

Example 9: The system of example 8, where the one or more non-linear traces comprise one or more traces that take the form of an undulating line and/or a non-linear ladder.

Example 10: The system of example 1, where the lens includes a conductive film and the multi-microdevice unit is embedded within the conductive film.

Example 11: The system of example 10, where the conductive film includes a metal mesh.

Example 12: The system of example 11, where a density of the metal mesh at a peripheral area of the conductive film is greater than a density of the metal mesh at a central area of the conductive film.

Example 13: The system of example 11, where the metal mesh includes an overcoat, added to the metal mesh via dye sublimation printing, that reduces reflection and/or glare of the metal mesh.

Example 14: The system of example 11, where a height of the metal mesh is modified by an image patterning laser to increase the optical transparency of the metal mesh.

Example 15: A wearable device including: a support structure, a lens, mounted to the support structure, a power source, and a multi-microdevice unit, positioned on the lens, including a first microdevice powered by a first type of current, a second microdevice powered by a second type of current, and a microconverter, where: the power source transmits the first type of current to the multi-microdevice where the first type of current is received by the first microdevice and the microconverter, and the microconverter converts the first type of current to the second type of current and transmits the converted second type of current to the second microdevice within the multi-microdevice unit.

Example 16: The wearable device of example 15, where: the multi-microdevice unit includes an antenna-LED unit, the first microdevice includes an antenna, the second microdevice includes one or more light emitting diodes (LEDs), the microconverter comprise a rectifier, the first type of current includes alternating current, and the second type of current includes direct current.

Example 17: The wearable device of example 15, where the wearable device includes a pair of augmented reality glasses.

Example 18: A method of manufacturing including providing a support structure, disposing, on the support structure, a power source that supplies a first type of power, mounting a lens to the support structure, and disposing, on the lens, a multi-microdevice unit including a first microdevice powered by the first type of power, a second microdevice powered by a second type of current, and a microconverter.

Example 19: The method of manufacturing of example 18, further including assembling the first microdevice, the second microdevice, and the microconverter to form the multi-microdevice unit.

Example 20: The method of manufacturing of example 18, further including connecting the light-emitting element to the controller via one or more non-linear traces.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof.

Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

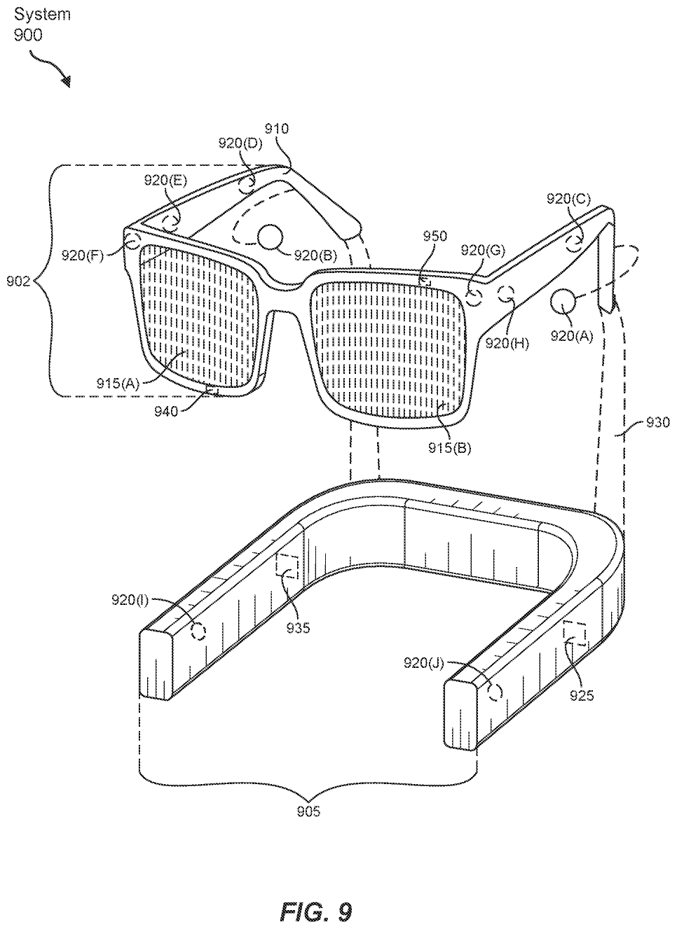

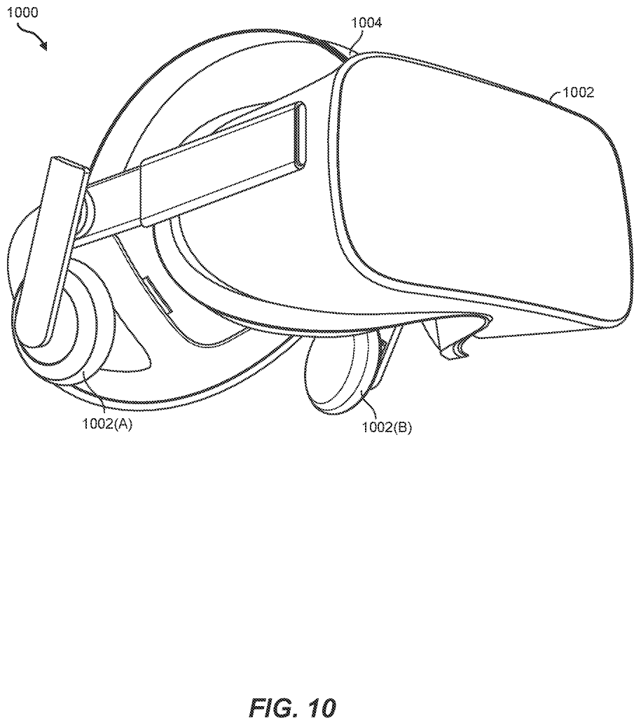

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 900 in FIG. 9) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented reality system 900 may include one or more sensors, such as sensor 940. Sensor 940 may generate measurement signals in response to motion of augmented-reality system 900 and may be located on substantially any portion of frame 910. Sensor 940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

In some examples, augmented-reality system 900 may also include a microphone array with a plurality of acoustic transducers 920(A)-920(J), referred to collectively as acoustic transducers 920. Acoustic transducers 920 may represent transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(J) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented reality system 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a BLUETOOTH connection). In still other embodiments, acoustic transducers 920(A) and 920(B) may not be used at all in conjunction with augmented-reality system 900.

Acoustic transducers 920 on frame 910 may be positioned in a variety of different ways, including along the length of the temples, across the bridge, above or below display devices 915(A) and 915(B), or some combination thereof. Acoustic transducers 920 may also be oriented such that the microphone array is able to detect sounds in a wide range of directions surrounding the user wearing the augmented-reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality.

For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information.

In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium-ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world.

Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A system comprising:
a support structure;
a lens, mounted to the support structure;
a power source; and
a multi-microdevice unit, positioned on the lens, comprising a first microdevice powered by alternating current, a second microdevice powered by direct current, and a microconverter, wherein:
the power source transmits the alternating current to the multi-microdevice where the alternating current is received by the first microdevice and by the microconverter; and
the microconverter converts the alternating current, received from the power source, to the direct current and transmits the converted second type of current to the second microdevice.

2. The system of claim 1, wherein the multi-microdevice unit comprises an antenna-LED unit.

3. The system of claim 2, wherein:
the first microdevice comprises an antenna;
the second microdevice comprises one or more light emitting diodes (LEDs); and
the microconverter comprise a rectifier.

4. The system of claim 3, further comprising a camera configured to detect an illuminance, emitted by at least one of the one or more LEDs, that has reflected off an eye of a user.

5. (canceled)

6. The system of claim 1, wherein:
the alternating current comprises a current with an operating frequency above a threshold range; and
the direct current comprises a current with an operating frequency below the threshold range.

7. The system of claim 1, wherein the power source is embedded within the support structure.

8. The system of claim 1, wherein the power source transmits the alternating current to the multi-microdevice unit via one or more non-linear traces.

9. The system of claim 8, wherein the one or more non-linear traces comprise one or more traces that take the form of at least one of an undulating line or a non-linear ladder.

10. The system of claim 1, wherein:
the lens comprises a conductive film; and
the multi-microdevice unit is embedded within the conductive film.

11. The system of claim 10, wherein the conductive film comprises a metal mesh.

12. The system of claim 11, wherein a density of the metal mesh at a peripheral area of the conductive film is greater than a density of the metal mesh at a central area of the conductive film.

13. The system of claim 11, wherein the metal mesh comprises an overcoat, added to the metal mesh via dye sublimation printing, that reduces at least one of reflection or glare of the metal mesh.

14. The system of claim 11, wherein a height of the metal mesh is modified by an image patterning laser to increase the optical transparency of the metal mesh.

15. A wearable device comprising:
a support structure;
a lens, mounted to the support structure;
a power source; and
a multi-microdevice unit, positioned on the lens, comprising a first microdevice powered by alternating current, a second microdevice powered by direct current, and a microconverter, wherein:
the power source transmits the alternating current to the multi-microdevice where the alternating current is received by the first microdevice and the microconverter; and
the microconverter converts the alternating current to the direct current and transmits the converted second type of current to the second microdevice.

16. The wearable device of claim 15, wherein:
the multi-microdevice unit comprises an antenna-LED unit;
the first microdevice comprises an antenna;
the second microdevice comprises one or more light emitting diodes (LEDs); and
the microconverter comprises a rectifier.

17. The wearable device of claim 15, wherein the wearable device comprises a pair of augmented reality glasses.

18. A method of manufacturing comprising:
providing a support structure;
disposing, on the support structure, a power source that supplies alternating current;
mounting a lens to the support structure; and
disposing, on the lens, a multi-microdevice unit comprising a first microdevice powered by the alternating current, a second microdevice powered by direct current, and a microconverter configured to convert the alternating current to the direct current.

19. The method of manufacturing of claim 18, further comprising assembling the first microdevice, the second microdevice, and the microconverter to form the multi-microdevice unit.

20. The method of manufacturing of claim 18, further comprising connecting the multi-microdevice unit to the power source via one or more non-linear traces.

21. The method of manufacturing of claim 20, wherein the one or more non-linear traces comprise one or more traces that take the form of at least one of an undulating line or a non-linear ladder.
